(19) United States
(12) Patent Application Publication
(10) Pub. No.: US 2025/0325972 A1
(43) Pub. Date: Oct. 23, 2025

(54) CATALYST NETWORK COMPRISING A NOBLE METAL WIRE MADE OF A DISPERSION-STRENGTHENED NOBLE METAL ALLOY

(71) Applicant: HERAEUS PRECIOUS METALS GMBH & CO. KG, Hanau (DE)

(72) Inventors: Verena WALD, Hanau (DE); Uwe JANTSCH, Hanau (DE); Dirk MAIER, Hanau (DE)

(21) Appl. No.: 18/869,070

(22) PCT Filed: Feb. 27, 2023
(86) PCT No.: PCT/EP2023/054820

§ 371 Date: Nov. 25, 2024

(30) Foreign Application Priority Data
May 25, 2022 (EP) 22175272.8

(51) Int. Cl. B01J 35/58; B01J 23/42; B01J 23/63; C01B 21/26; C01C 3/02

(52) U.S. Cl. CPC B01J 35/58; B01J 23/42; B01J 23/63; C01B 21/265; C01C 3/0216

(57) ABSTRACT

A catalyst network comprising at least one noble metal wire that contains at least one dispersion-strengthened noble metal alloy. The invention also relates to a catalyst system containing at least one catalyst network according to the invention, and to a method for the catalytic oxidation of ammonia in which a catalyst network according to the invention is used.

The present invention relates to a catalyst network comprising at least one noble metal wire that contains at least one dispersion-strengthened noble metal alloy. The invention also relates to a catalyst system containing at least one catalyst network according to the invention, and to a method for the catalytic oxidation of ammonia in which a catalyst network according to the invention is used.

Catalyst networks are used in particular in flow reactors for gas reactions. They are used, for example, in the preparation of hydrocyanic acid by the Andrussow process or in the preparation of nitric acid by the Ostwald process. Suitable catalysts must provide a large catalytically active surface. In general, therefore, catalyst networks in the form of three-dimensional, gas-permeable structures of noble metal wires are used. Collecting systems for recovering evaporated catalytically active components are also frequently based on such lattice structures. Usually, a plurality of networks are expediently arranged one behind the other and combined to form a catalyst system. The catalyst systems consist of 3 to 50 catalyst networks lying one over the other, wherein this number substantially depends on the conditions in the reactor, for example the operating pressure and the mass flow rate of the gases. The diameter of the networks reaches 6 m in certain burners.

The catalyst networks usually consist of single-layer or multi-layer networks in the form of knitted fabrics and/or woven fabrics. The individual networks are made of fine noble metal wires that predominantly contain platinum (Pt), palladium (Pd), rhodium (Rh) or alloys of these metals. The choice of material of the noble metal wire is determined, inter alia, by the position and function of the catalyst network in the catalyst system. In particular, catchment networks may also contain further constituents, for example nickel, in addition to noble metals. In order to increase the catalytically active available surface, the catalyst networks often have a three-dimensional structure in addition to their planar extension.

The catalyst networks are used at high temperatures (>800° C.) in the reactors. Due to the pressure difference and the high temperatures in the reactor, the network structures are compressed, which decreases not only the free surface area accessible to the reactants but also the flow conditions. These effects result in efficiency decreasing as duration of use increases. Due to the high noble metal prices, it is economically unattractive to produce the catalyst networks from thicker and therefore stronger noble metal wires. In addition, this is technically unattractive because the pressure drop increases as wire diameter increases, which would have a detrimental effect on the overall efficiency of the process. It is therefore desirable to optimize the mechanical stability of the catalyst networks as well as the amount of noble metal used for a given catalytic activity. Another problem that can occur during ammonia oxidation is the fusion and/or sintering of a plurality of catalyst networks arranged one behind the other.

In the state of the art, an improvement in the mechanical stability of catalyst networks is usually achieved by the shape of the noble metal wires used. EP 0652985 A1, for example, discloses a wire made of platinum composites which comprises at least one helical sub-portion. In EP 3523024 A1, in order to increase the mechanical strength of the catalyst networks, it is proposed to use for their production a wire made of a plurality of filaments twisted together.

To increase the strength of catalyst networks, EP 3256244 A1 proposes the use of a three-dimensional structure in which multiple catalyst network layers are connected to one another via so-called pole threads.

The solutions disclosed in the prior art therefore require a more complex production of the noble metal wires or of the catalyst networks.

Metal materials often have a higher heat resistance if they contain a small amount of insoluble particles of base metal oxides evenly distributed within them. Such materials are called dispersion-strengthened or dispersion-hardened. The production can be carried out using different methods (see in particular for the production of platinum-based materials: E. Drost, H. Gölitzer, M. Poniatowski, S. Zeuner: Platinum Materials for High-temperature Use, Metall 50 (1996), 492-498). Dispersion-strengthened platinum materials are characterized, for example, by their resistance to corrosion and oxidation at high temperatures and are used in the glass industry, among other things, because of their resistance to glass melts. The production and processing of these materials is described, for example, in publications GB 1340076 A, EP 0683240 A2, EP 1188844 A1, EP 1964938 A1 and EP 3077556 A1. However, their use for catalyst networks is not known.

The object of the invention is to overcome some of the disadvantages of the prior art. The object has been to provide a catalyst network that ensures a high product yield that is also stable over time while also having a long service life. In particular, it has been an object of the present invention to provide a catalyst network which, under the conditions of use in a flow reactor, has a reduced compression in order to ensure increased long-term stability.

The object is achieved by a catalyst network comprising at least one noble metal wire, characterized in that the at least one noble metal wire contains at least one dispersion-strengthened noble metal alloy which, in addition to at least one noble metal, comprises at least one non-noble metal, wherein the at least one non-noble metal is selected from the group consisting of zirconium, cerium, scandium and yttrium and the at least one non-noble metal is at least partially present as an oxide.

The invention further provides a catalyst system and a method for using such a catalyst network.

Surprisingly, it has emerged that by using dispersion-strengthened noble metal alloys for at least one noble metal wire of the catalyst network, the service life of the networks can be significantly increased while maintaining the same catalytic efficiency. Without wishing to be bound by any theory, the use of a dispersion-strengthened noble metal wire in the manufacture of the networks presumably leads to a higher mechanical strength at high operating temperatures, which can lead to a reduced compression over the service life.

The present invention relates to a catalyst network. A catalyst network is understood to mean a single-layer or multi-layer gas-permeable fabric. The surface formation of the catalyst networks is achieved by intertwining one or more noble metal wires to form a mesh. Catalyst networks can be produced, for example, by weaving, braiding or knitting a noble metal wire or a plurality of noble metal wires. The structure of the catalyst networks can be set in a targeted manner by the use of different weaving or knitting patterns and/or different mesh sizes.

Catalyst networks are typically used in flow reactors. The catalyst networks are installed in the reaction zone in a plane perpendicular to the flow direction of the fresh gas.

In preferred embodiments, the catalyst network can comprise a three-dimensional structure. In the context of this application, networks are understood as flat, two-dimensional objects. A three-dimensional structure is understood to mean that the catalyst network also comprises, in addition to its planar, two-dimensional extension, an extension into the third spatial dimension. Catalyst networks with a three-dimensional structure have a larger free surface area and better material transport conditions between the gas and the surface, which advantageously affect the catalytic effectiveness and can reduce the pressure drop in the flow reactor. A three-dimensional structure can be obtained by using at least one noble metal wire having a two- or three-dimensional structure or by texturing the catalyst network. Three-dimensional structures of the catalyst network may be, for example, wave-shaped or coil-shaped. To produce such structures, an initially planar catalyst network may be subjected to a process step in which a three-dimensional structure is embossed or produced by folding.

The catalyst network contains at least one noble metal wire. A noble metal wire is understood to be a wire consisting of noble metal or a noble metal alloy. A noble metal alloy is understood to mean an alloy that consists of noble metal to an extent of more than 50 wt. %. The fact that an alloy consists of more than 50 wt. % of noble metal means that the weight proportion of noble metal makes up at least 50 wt. % of the weight of the total alloy.

The noble metal is preferably selected from the group consisting of the platinum metals, gold and silver. Platinum metals are understood to mean the metals of the so-called platinum group, i.e., platinum (Pt), palladium (Pd), iridium (Ir), rhodium (Rh), osmium (Os) and ruthenium (Ru).

The at least one noble metal wire comprises at least one dispersion-strengthened noble metal alloy.

The dispersion-strengthened noble metal alloy may contain a single noble metal or a combination of noble metals. Preferably, the dispersion-strengthened noble metal alloy consists of at least 50 wt. % of the at least one noble metal, based on the total weight of the dispersion-strengthened noble metal alloy, particularly preferably at least 70 wt. %, in particular at least 90 wt. %, most preferably at least 99 wt. %.

Preferably, the at least one noble metal of the dispersion-strengthened noble metal alloy is selected from the group consisting of platinum, palladium, rhodium and mixtures thereof.

Particularly preferably, the at least one noble metal of the dispersion-strengthened noble metal alloy is platinum; in this case the dispersion-strengthened noble metal alloy is a dispersion-strengthened platinum alloy. Particularly advantageously, the dispersion-strengthened platinum alloy consists of at least 50 wt. % platinum, preferably at least 70 wt. %, particularly preferably at least 80 wt. %.

Furthermore, the dispersion-strengthened platinum alloy can also comprise at least one other noble metal. Such a dispersion-strengthened platinum alloy preferably comprises at least 70 wt. % platinum and a maximum of 29.95 wt. % of the at least one further noble metal, in particular at least 80 wt. % platinum and a maximum of 19.95 wt. % of the at least one further noble metal. The at least one further noble metal is preferably selected from the group consisting of ruthenium, rhodium, gold, palladium, iridium and mixtures thereof. Preferably, the dispersion-strengthened platinum alloy is a platinum-rhodium alloy, a platinum-gold alloy, a platinum-palladium alloy, a platinum-palladium-rhodium alloy or a platinum-iridium alloy.

The dispersion-strengthened noble metal alloy comprises at least one non-noble metal selected from the group consisting of zirconium, cerium, scandium and yttrium.

Preferably, 0.005 wt. % to 1.0 wt. %, particularly preferably 0.1 wt. % to 0.8 wt. % and especially preferably 0.2 wt. % to 0.5 wt. % of the at least one non-noble metal is contained in the dispersion-hardened noble metal alloy, based on the total weight of the dispersion-hardened noble metal alloy.

The at least one non-noble metal is present at least partially as an oxide. It can be provided that the at least one non-noble metal is at least 70% oxidized, preferably at least 90%, particularly preferably 99% and especially preferably completely oxidized. Here, all oxidation states of the at least one non-noble metal are taken into account, so that preferably at most 30%, particularly preferably at most 10%, in particular at most 1% of the at least one non-noble metal is present as metal, i.e., in the formal oxidation state 0. The proportion of the at least one non-noble metal present as oxide gives the ratio between the amount of the at least one non-noble metal in oxidation states higher than 0 and the total amount of the at least one non-noble metal. The proportion of the at least one non-noble metal present as an oxide can be determined by carrier gas hot extraction. For this purpose, the oxygen content is measured indirectly by reacting the oxygen from a sample with carbon and quantifying the content of resulting CO₂ using IR spectroscopy. This determination is based on the assumption that the entire oxygen content of the sample is due to oxidic non-noble metal. In the case of mixtures of a plurality of non-noble metals, it is assumed that the proportion of oxidized and non-oxidized non-noble metal is the same for the different non-noble metals.

The oxide of the at least one non-noble metal is preferably in the form of particles uniformly dispersed in the noble metal matrix; the particles preferably have a size in the range of 1 nm-1 μm, in particular in the range of 50 nm-500 nm. Preferably, the particles are smaller than 1 μm, in particular smaller than 500 nm, particularly preferably smaller than 100 nm.

The at least one non-noble metal may also comprise a mixture of a plurality of non-noble metals. Preferred mixtures of non-noble metals comprise yttrium and zirconium, yttrium and cerium, yttrium and scandium, zirconium and cerium, zirconium and scandium, cerium and scandium, yttrium and zirconium and cerium, or yttrium and zirconium and scandium.

Preferably, the proportion of zirconium in mixtures of a plurality of non-noble metals is in the range of 70-98 mol %, more preferably in the range of 80-95 mol %, particularly preferably in the range of 85-93 mol % and most preferably in the range of 90-92 mol %.

The proportion of yttrium in mixtures of a plurality of non-noble metals is preferably in the range of 2-30 mol %, more preferably in the range of 3.5-20 mol %, particularly preferably in the range of 5-15 mol %, and most preferably in the range of 6-10 mol %.

The proportion of cerium in mixtures of a plurality of non-noble metals is preferably in the range of 2-30 mol %, more preferably in the range of 3.5-20 mol %, particularly preferably in the range of 5-15 mol %, and most preferably in the range of 6-10 mol %.

Preferred mixtures of a plurality of non-noble metals consist of
(a) 2-30 mol %, preferably 7-15 mol % yttrium and 70-98 mol %, preferably 85-93 mol % zirconium,
(b) 2-30 mol %, preferably 7-15 mol % yttrium and 70-98 mol %, preferably 85-93 mol % cerium,
(c) 2-30 mol %, preferably 7-15 mol % cerium and 70-98 mol %, preferably 85-93 mol % zirconium,
(d) 2-30 mol %, preferably 3-15 mol % yttrium, 2-30 mol %, preferably 3-15 mol % cerium and 40-96 mol %, preferably 70-94 mol % zirconium,
(e) 2-30 mol %, preferably 3-15 mol % yttrium, 2-30 mol %, preferably 3-15 mol % scandium and 40-96 mol %, preferably 70-94 mol % zirconium.

Preferably, the dispersion-strengthened noble metal alloy is pure noble metal or a noble metal alloy into which, apart from impurities, only the at least partially oxidized non-noble metals are mixed. In other words, the dispersion-strengthened noble metal alloy preferably consists of the at least one noble metal, the at least partially oxidized at least one non-noble metal and impurities; the dispersion-strengthened noble metal alloy therefore preferably consists of the at least one noble metal, the at least one non-noble metal, oxygen and impurities.

Impurities of dispersion-strengthened noble metal alloy and non-noble metals or oxides thereof are understood to mean customary impurities that are intended to enter the dispersion-strengthened noble metal alloy or that have unavoidably entered the starting materials in the course of the preparation process or that could not be (completely) removed from the raw materials with reasonable effort. The proportion of impurities in total is preferably no more than 1 wt. % of the described dispersion-strengthened noble-metal alloy, preferably no more than 0.5 wt. %.

Particularly preferably, the dispersion-strengthened noble metal alloy is a dispersion-strengthened platinum alloy, i.e., pure platinum or a platinum alloy into which, apart from impurities, only the at least partially oxidized non-noble metals are mixed. In other words, the dispersion-strengthened platinum alloy preferably consists of platinum and optionally at least one further noble metal, the at least partially oxidized at least one non-noble metal and impurities; the dispersion-strengthened platinum alloy therefore preferably consists of platinum and optionally at least one further noble metal, the non-noble metal, oxygen and impurities. The proportion of impurities in total is preferably no more than 1 wt. % of the described dispersion-strengthened platinum alloy, preferably no more than 0.5 wt. %. In particularly preferred embodiments, the dispersion-strengthened platinum alloy consists of platinum, rhodium, the at least partially oxidized at least one non-noble metal and impurities.

Examples of preferred dispersion-strengthened platinum alloys are PtRh(1-20)NEM(0.005-1) alloy or PtPd(10-20)Rh(1-5)NEM(0.005-1) alloys, very particularly preferably PtRh3NEM(0.005-1), PtRh4NEM(0.005-1), PtRh5NEM(0.005-1), PtRh8NEM(0.005-1), PtRh10NEM(0.005-1), PtRh15NEM(0.005-1), PtPd5Rh5NEM(0.005-1), PtPd5Rh3NEM(0.005-1), PtPd5Rh4NEM(0.005-1), PtPd15Rh3NEM(0.005-1) or PtPd15Rh4NEM(0.005-1). PtRh(X)NEM(0.005-1) means that the alloy consists of, in addition to impurities, X wt. % rhodium, 0.005 to 1 wt. % non-noble metal (NEM), the oxygen of the at least partially oxidized non-noble metal and platinum; PtPd(Y)Rh(X)NEM(0.005-1) means that the alloy consists of, in addition to impurities, Y wt. % palladium, X wt. % rhodium, 0.005 to 1 wt. % non-noble metal (NEM), the oxygen of the at least partially oxidized non-noble metal and platinum.

The oxide of the at least one non-noble metal can be added to the noble metal or to the noble metal alloy during the production of the dispersion-strengthened noble metal alloy. Alternatively, the oxide of the at least one non-noble metal may be formed in situ by partial oxidation of the at least one non-noble metal during the preparation of the dispersion-strengthened noble metal alloy.

The dispersion-strengthened noble metal alloy can be produced by powder metallurgy or melt metallurgy.

For the powder-metallurgical production of the dispersion-strengthened noble metal alloy, for example, powder of a noble metal composition can be mechanically mixed with powder of the oxide(s) of the at least one non-noble metal. Powder-metallurgical production can also be carried out by simultaneous precipitation from salt solutions, by evaporation of solutions containing at least precursors of the intended components or by spraying such solutions into flames. Further manufacturing steps may comprise annealing the powder, pressing it into a mold and sintering.

Preferably, it can be provided that a noble metal alloy is first produced by melt metallurgy, which alloy comprises at least one noble metal and at least one non-noble metal. An oxidation step can be carried out next in which the at least one non-noble metal contained in the noble metal alloy is at least partially oxidized by a heat treatment in an oxidizing medium. The dispersion-strengthened noble metal alloy thus produced can then be formed into a noble metal wire and particularly preferably annealed before and/or after.

The catalyst network according to the invention comprises at least one noble metal wire. The catalyst network can consist entirely of noble metal wire, but it can also comprise other components, such as wires or yarn made of non-noble metals or non-metal materials. Examples of non-metal materials are organic and ceramic materials.

Preferably, a noble metal wire is used that has a diameter of 40 to 150 μm, preferably 50 to 130 μm.

The at least one noble metal wire can be designed as a round wire, i.e., having a round cross-section. In another embodiment, the at least one noble metal wire can be designed as a flattened round wire or as a wire having a different cross-section.

The at least one noble metal wire can have a two- or three-dimensional structure. The at least one noble metal wire can comprise, for example, one or more undulating, stepped or helical longitudinal portions or can be formed as an undulating, stepped or helically bent wire over its entire length. If the at least one noble metal wire comprises a helical longitudinal portion, both the active catalyst surface of a catalyst network and the mass of the catalyst network may be adjusted relative to a surface unit via the number of windings of the helical longitudinal portions. When a noble metal wire having a two- or three-dimensional structure is used, a catalyst network made therefrom will have a three-dimensional structure; for the long-term stability thereof, the use of dispersion-hardened noble metal alloys has proven to be particularly advantageous.

The at least one noble metal wire may comprise a plurality of wires, in this case also referred to as filaments. In such cases, the at least one noble metal wire can have increased strength, which improves the long-term stability of the catalyst network. The filaments can all consist of the same material, i.e., all containing noble metal, or consist of different materials, which in turn do not have to all contain noble metal.

The filaments may be twisted together; in these cases the at least one noble metal wire comprises a rope-like structure. It can also be advantageous if the at least one noble metal wire comprises at least one filament that is helically wound around at least one further filament.

The at least one noble metal wire may comprise at least one filament made of a dispersion-strengthened noble metal alloy and at least one further filament made of a noble metal alloy that is not dispersion-strengthened. In particular, the at least one noble metal wire may comprise at least one filament made of a dispersion-strengthened platinum alloy and at least one further filament made of a platinum alloy that is not dispersion-strengthened. Catalyst networks comprising such noble metal wires have proven to be particularly advantageous for the long-term stability and simultaneous high catalytic efficiency of catalyst networks that comprise at least one linear filament and at least one helical filament arranged around it.

In many cases, it can be advantageous that the catalyst network comprises at least one further noble metal wire, i.e., is formed from two or more noble metal wires. In these cases, the at least two noble metal wires may consist of the same material or of different materials. The at least two noble metal wires can have the same or different diameters and/or the same or different structures. It has proven to be advantageous if the at least one further noble metal wire comprises a platinum alloy, in particular a non-dispersion-strengthened platinum alloy.

The catalyst network according to the invention is suitable for the preparation of nitric acid by the Ostwald process. An ammonia-oxygen mixture flows through the catalyst network for catalytic ammonia combustion.

The catalyst network according to the invention is also suitable for preparing hydrocyanic acid by the Andrussow process. An ammonia-methane-oxygen mixture flows through the catalyst network.

The present invention also relates to a catalyst system for the catalytic oxidation of ammonia, comprising at least one catalyst network according to the invention. For preferred embodiments of the catalyst network, reference is made to the preceding statements.

Preferably, the catalyst system comprises a catalyst network stack; in other words, the catalyst system comprises at least two catalyst networks. The at least two catalyst networks can be the same or different. Depending on the intended use of the catalyst system and the reaction conditions in the flow reactor, catalyst networks having different or identical structures and different or identical noble metal wires can be combined with each other.

The catalyst system may comprise one or more catalyst network groups. A catalyst network group is understood to mean an ensemble of catalyst networks that are formed from at least one noble metal wire of the same composition. Typically, a catalyst network group comprises more than one catalyst network.

The catalyst system may also comprise further components.

In preferred embodiments, the catalyst system can comprise separating elements, for example in the form of intermediate networks. Such separating elements can be used to counteract compression and/or melting or sintering of adjacent catalyst networks or catalyst network groups under pressure loading. The separating element(s) preferably has/have limited flexibility compared to the catalyst networks.

Suitable separating elements are, for example, elements or networks made of a heat-resistant steel, typically a FeCrAl alloy such as Megapyr or Kanthal, stainless steel or of heat-resistant alloys, such as nickel-chromium alloys. The separating element or elements may also comprise a catalytically active coating comprising at least one noble metal.

The present invention also relates to a method for the catalytic oxidation of ammonia, in which a fresh gas containing ammonia is conducted over a catalyst network according to the invention. For preferred embodiments of the catalyst network, reference is made to the preceding statements.

The invention is explained below with reference to drawings, a compression test and an experiment concerning catalytic efficiency.

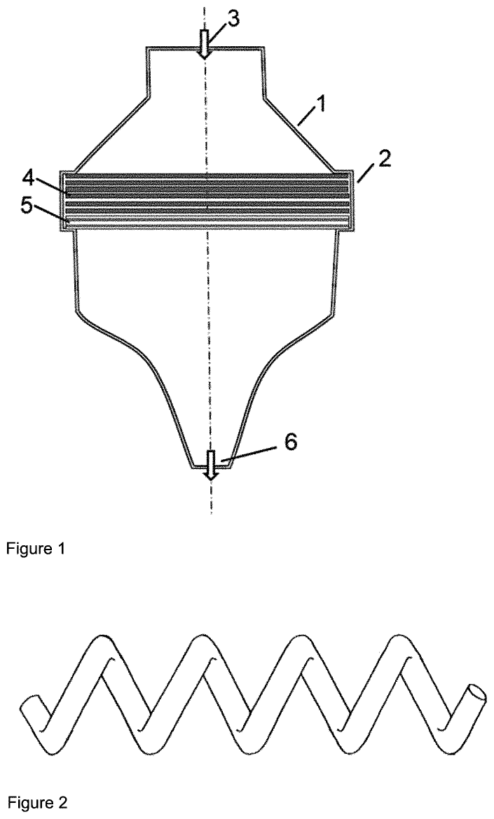

FIG. 1 schematically shows a vertically positioned flow reactor 1 for the heterogeneous catalytic oxidation of ammonia. The catalyst system 2 forms the actual reaction zone of the flow reactor 1. The catalyst system 2 comprises a plurality of catalyst networks 4 which are arranged one behind the other in the flow direction 3 of the fresh gas and behind which a plurality of catchment networks 5 can be arranged. The effective catalyst network diameter can be up to 6 m. The networks used are in each case textile fabrics produced by means of machine weaving or knitting of noble metal wires.

A corresponding flow reactor is used, for example, for the synthesis of hydrocyanic acid according to the Andrussow process. As fresh gas, an ammonia-methane-air mixture under increased pressure is introduced in flow direction 3. Upon entry into the catalyst system 2, the gas mixture is ignited and a subsequent exothermic combustion reaction takes place. The overall reaction is:

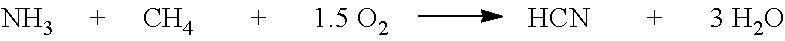

This exothermic reaction increases the temperature of the gases to up to 1100° C.

### Compression Test

Catalyst networks were woven from wires having a diameter of 76 μm. A linear warp wire and a helical weft wire having 17.5 turns/cm were used. FIG. 2 shows the structure of the helical wire. Both wires contained a PtRh10 alloy, a standard industrial alloy. In the case of the catalyst networks according to the invention, the helical wire was dispersion strengthened.

Stacks of 24 catalyst networks (L×W: 50 mm×50 mm) were each subjected to a weight of 1 kg over a period of 3 days at an ambient temperature of 1200° C. The thickness of the network stacks was measured at 16 points before and after heat treatment. Both network packages had a thickness of approximately 8 mm at the beginning of the test. The compression was determined according to the formula

$$compression = \frac{( Δ thickness )}{initialthickness}$$

Table 1 compares the results of the compression test. The network package using the catalyst networks according to the invention (EB) showed a significantly lower compression than the network package in which the networks were made entirely of non-dispersion-strengthened standard wire (VB).

TABLE 1

| | Compression [%] |
|---|---|
| VB | 40.5% |
| EB | 22.5% |

The compression stability of the tested catalyst network package was improved by using a dispersion-strengthened platinum wire. In connection with this, a positive effect on the long-term efficiency of a corresponding catalyst system is expected.

### Efficiency in the Flow Reactor

In a flow reactor as shown in FIG. 1, the efficiency of catalyst systems consisting of 10 catalyst networks, each having a composition analogous to that in the comparative example and in the example according to the invention involving the oxidation of ammonia was compared.

Fresh gas was introduced from above into reactor 1 under increased pressure. The fresh gas was an ammonia-air mixture having a nominal ammonia content of 10.7 vol. % and a preheating temperature of 175° C. When entering the catalyst system 2, the gas mixture is ignited and a subsequent exothermic combustion reaction occurs. The following main reaction takes place:

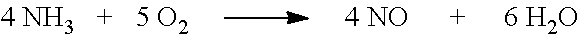

In this case, ammonia (NH₃) is converted to nitrogen monoxide (NO) and water (H₂O). The nitrogen monoxide (NO) formed reacts in the outflowing reaction gas mixture (symbolized by the directional arrow 7 indicating the flow direction of the outflowing reaction gas mixture) with excess oxygen to form nitrogen dioxide (NO₂), which is reacted with water in a downstream absorption system to form nitric acid (HNO₃).

The measurement of the catalytic efficiency (i.e., the product yield of NO) has the following sequence:
1. It is ensured that the catalyst system is suitable for the complete conversion of the ammonia used. That means that NH₃ in the product gas is no longer present in a significant amount, which is checked by means of mass spectrometric analysis of the product gas.
2. Simultaneous removal of a sample of NH₃/air upstream of the catalyst packing and a sample from the product gas downstream in respectively independent evacuated pistons. The mass of the gas is determined by weighing.
3. The NH₃/air mixture is absorbed in distilled water and titrated by means of 0.1 N sulfuric acid and methyl red after color change.
4. The nitrous product gases are absorbed in 3% sodium peroxide solution and titrated by means of 0.1 N sodium hydroxide solution and methyl red after color change.
5. The catalytic efficiency Eta results from Eta=100×COₙ/Cₐ, where Cₐ is the average NH₃ concentration of 7 individual measurements in the fresh gas in percent by weight and Co is the mean NOx concentration of 7 individual measurements expressed as percent by weight of the NH₃ which has been oxidized to form NOx.
6. Separately, the volumetric proportion of N₂O in the product gas is determined by means of gas chromatography.

Table 2 compares the catalyst efficiency of the catalyst systems (yield of NO in %) for different fresh gas flow rates. The abbreviation “tN/m²d” stands for “tons of nitrogen (from ammonia) per day and a standardized effective cross-sectional area of the catalyst system of one square meter.”

TABLE 2

| Fresh gas flow rate | | Efficiency [%] |
|---|---|---|
| 22.5 tN/m²d | VB | 94.9 |
| 5 bar | EB | 95.2 |
| 30 tN/m²d | VB | 92.2 |
| 9 bar | EB | 92.3 |
| 55 tN/m²d | VB | 89.7 |
| 9 bar | EB | 90.4 |

Both test systems showed comparable catalytic efficiency at all tested fresh gas flow rates. The results demonstrate that the use of the dispersion-strengthened platinum alloy does not impair the catalytic activity of the catalyst network.

1. A catalyst network comprising at least one noble metal wire,
wherein the at least one noble metal wire contains at least one dispersion-strengthened noble metal alloy which, in addition to at least one noble metal, comprises at least one non-noble metal, and
wherein the at least one non-noble metal is selected from the group consisting of zirconium, cerium, scandium and yttrium and the at least one non-noble metal is at least partially present as an oxide.

2. The catalyst network according to claim 1, wherein the catalyst network has a three-dimensional structure.

3. The catalyst network according to claim 1, wherein the proportion of the at least one noble metal is at least 50 wt. % based on the total weight of the dispersion-strengthened noble metal alloy.

4. The catalyst network according to claim 1, wherein the dispersion-strengthened noble metal alloy consists of the at least one noble metal, the at least partially oxidized non-noble metal and impurities.

5. The catalyst network according to claim 1, wherein the at least one noble metal is selected from the group consisting of platinum, palladium, rhodium and mixtures thereof.

6. The catalyst network according to claim 1, wherein the dispersion-strengthened noble metal alloy is a platinum alloy.

7. The catalyst network according to claim 1, wherein the dispersion-strengthened noble metal alloy contains 0.005 wt. % to 1.0 wt. % of the at least one non-noble metal.

8. The catalyst network according to claim 1, wherein the at least one non-noble metal is at least 70% oxidized.

9. The catalyst network according to claim 1, wherein the at least one noble metal wire comprises a plurality of filaments.

10. The catalyst network according to claim 1, wherein the at least one noble metal wire has a two- or three-dimensional structure.

11. The catalyst network according to claim 10, wherein the at least one noble metal wire comprises a helical longitudinal portion.

12. The catalyst network according to claim 1, wherein the catalyst network comprises at least one further noble metal wire.

13. The catalyst network according to claim 12, wherein the at least one further noble metal wire comprises a platinum alloy.

14. A catalyst system for the catalytic oxidation of ammonia, comprising at least one catalyst network according to claim 1.

15. A method for the catalytic oxidation of ammonia in which a fresh gas containing ammonia is conducted over at least one catalyst network according to claim 1.
